(19) United States
(12) Patent Application Publication
(10) Pub. No.: US 2006/0035003 A1
(43) Pub. Date: Feb. 16, 2006

(54) Soy protein containing food product and process for preparing same

(76) Inventors: Matthew K. McMindes, Chesterfield, MO (US); Mitchell A. Kaestner, Fenton, MO (US); Michael W. Finfrock, West Chester, OH (US)

Correspondence Address: SOLAE, LLC, PO BOX 88940, ST. LOUIS, MO, 63188, US

(21) Appl. No.: 11/244,941

(22) Filed: Oct. 6, 2005

Related U.S. Application Data
(63) Continuation-in-part of application No. 10/959,277, filed on Oct. 6, 2004.
Application No. 10/959,277 is a continuation-in-part of application No. 10/919,421, filed on Aug. 16, 2004.

(51) Int. Cl. A23L 1/20

(52) U.S. Cl. 426/634

(57) ABSTRACT

This invention relates to a soy protein containing food product comprising; (A) a soy protein material selected from the group consisting of a soy protein flour, a soy protein concentrate, a soy protein isolate and mixtures thereof; (B) a humectant comprising (i) a colorant and at least one selected from the group consisting of (ii) a flavoring agent, (iii) a triglyceride, (iv) a food grade acid or acidic salt, (v) a food grade base or basic salt, and (vi) a food grade emulsion; and (C) water. In another embodiment, the invention is directed to a process for preparing a soy protein containing food product.

### CROSS REFERENCE TO RELATED APPLICATIONS

This is a continuation-in-part patent application of U.S. patent application Ser. No. 10/919,421, filed on Aug. 16, 2004.

### FIELD OF THE INVENTION

The present invention relates to a soy protein containing food product and a process for preparing a soy protein containing food product. The soy protein containing food product may be 100% meat free or may contain up to 50% of a meat.

### BACKGROUND OF THE INVENTION

Various sources of protein, other than natural meat protein, have been used in what are known as meat analog products as a substitute for the natural meat protein based products. In order to make such analog products more acceptable to the consumer, it is necessary to provide them with a color that is as close as possible to that of the natural meat protein based products. In preparing protein based analog products which are designed to simulate natural red meat based products, the coloring agent that has been used to date, for the most part, has been monascus red. However, it has been found that the use of colors other than monascus red as a coloring agent in soy isolate based analog products made by conventional procedures produces an analog product which has an undesirable blue/brown color, rather than a desired pink/orange color.

Steaks and roasts are universally popular foods. However, the rising cost of beef is likely to limit how often these products can be enjoyed by the average family. Thus, a need exists for structured meat products which closely simulate natural steaks and roasts in appearance, taste, texture and nutritional value, but which cost less. One object of the present invention is to provide such structured meat products. A number of features characterize a good natural steak or roast. When uncooked, each has an appearance characterized by a certain shape and size, often with a strip of white fat forming a cap or rim for the lean, red muscle. During cooking, the meat exhibits certain shrinkage characteristics, including changes in both size and shape. The cooked product exhibits distinctive characteristics of appearance, taste, texture, tenderness, juiciness and absence or presence of fat, gristle and sinew. These characteristics affect not only consumer product acceptance and meal enjoyment, but also affect both the manner of sale and preparation of the products.

A natural, high-grade steak includes a portion of red muscle which often is marbled with fat. This fat content results in juiciness on cooking and improves the taste of the meat. The texture and toughness of the steak is determined by the arrangement of connective tissue in the muscle, and by the presence or absence of gristle. The latter, while visible in the raw steak, cannot easily be removed without breaking up the physical integrity of the steak. The fat cap or rim advantageously achieves a brownish appearance on cooking, and adds to the juiciness and taste of the meat.

Industrial production of textured soy proteins in the form of meat-like products has been underway for several decades. The literature is enormous. Soy protein is known to be plentiful and can be spun, extruded and fabricated into a wide variety of meat replacing products.

The best commercial soy based meat substitutes are expensive and perishable. These are sold either frozen or dry. In their frozen form they must be thawed to use. In their dry form they must be rehydrated to resemble meat. However, drying notably alters and diminishes quality. The poorer soy based meat substitutes are beany to taste, coarse in nature and are sold dry. They are not intended to be used alone.

It would be useful if an inexpensive soy based meat substitute could be manufactured which more closely resembles meat, and which could be maintained in such a condition that it could be used directly. In such a product four conditions would have to be met: (1) the food would have to be less expensive than the meat which it attempts to replace; (2) it should be so similar to meat in texture and moisture content as to permit use in the same manner that meat would be used; (3) it should have appropriate nutritional values; and (4) it should be stable in storage.

Existing art in producing commercial textured soy protein materials now is yielding increasingly palatable products. Bean flavors and tastes are being diminished. Protein content is increasing, now upwards of 70% and more. Price per pound is decreasing. Hence, the first condition above, is being resolved. Such available textured soy products, however, are sponge-like in nature. As such, when they are squeezed with the fingers, for example, the liquid they contain when hydrated is readily released. It exudes too quickly to be similar to meat. With meat, such application of pressure results in some release of fluid or juice, but not as a sponge does.

Various mixtures of raw materials are being used to modify extruded soy product texture. Included is the wheat protein gluten. When gluten is added to a dry mix and the mix is then extruded, permanent alterations in the texture of the soy gluten base indeed result. Protein quality is also improved. However in so doing, the gluten is denatured in the extrusion process and the finished product loses the ability to retain liquids which ability was exhibited originally by the starting materials.

All the presently used textured soy protein manufacturing steps result in an inadequate ability to retain water, water soluble and fat soluble materials. The soy protein is rendered insoluble. All thus result in finished meat substitutes which fail to perform as meat itself does. Because of this poor water retention there is also difficulty in retaining color necessary to create meat appearance, particularly in red meat.

Animal meat proteins are a source of quality nutrition in the human diet. Such proteins are desired for their balance of flavor, nutritional value, and serve as the single most complete source of essential amino acids. Meat and meat products have historically been a priority in the diets of most people, but have become increasingly cost prohibitive. As a result, filler ingredients have been added to enhance nutritional quality and lower production costs. Vegetable components can be added to neutralize cholesterol. Fat replacement ingredients, such as starches and flours, can be added to further enhance nutritional quality. Other ingredients can be added to enrich and flavor the resulting products for acceptance within a particular culture. The method and product described herein not only provides a source of protein enrichment having an extended shelf life without refrigeration, but also offers a nutritionally sound product which can be made at cost lower than that of conventional meat protein based products extended by fillers.

### SUMMARY OF THE INVENTION

This invention relates to a soy protein containing food product comprising;
(A) a soy protein material selected from the group consisting of a soy protein flour, a soy protein concentrate, a soy protein isolate and mixtures thereof;
(B) a humectant comprising
   (i) a colorant and at least one selected from the group consisting of
   (ii) a flavoring agent,
   (iii) a triglyceride,
   (iv) a food grade acid or acidic salt,
   (v) a food grade base or basic salt, and
   (vi) a food grade emulsion; and
(C) water.

In another embodiment, the invention discloses a process for preparing a soy protein containing food product comprising the steps of; hydrating
(A) a soy protein material selected from the group consisting of at least one of a soy protein flour, a soy protein concentrate and a soy protein isolate, and; adding
(B) a humectant comprising
   (i) a colorant and at least one of
   (ii) a flavoring agent,
   (ii) a triglyceride,
   (iv) a food grade acid or acidic salt,
   (v) a food grade base or basic salt, or
   (vi) a food grade emulsion; and
      mixing the hydrated soy protein material and the humectant to produce a soy protein containing food product having a moisture content of at least about 50% by weight.

Both the product and the process for making the product may further comprise an animal fat and a meat.

### DETAILED DESCRIPTION OF THE INVENTION

The soy protein containing food product, may be a 100% meat-free product or may contain up to 50% by weight meat on a moisture free basis. This food product is distinguished in having coloration similar to the various colors of meat in both the uncooked state and the various cooked states. In the uncooked state, the product, both interior and exterior is a red color. In the cooked states, the interior color of the product, is a red, reddish-brown or brown color and the exterior color is brown. A red interior color with a brown exterior color indicates a product resembling a piece of meat in the rare state. An interior reddish-brown color of varying degrees of redness (from red to pinkish-brown with an exterior color of brown) represents meat in the medium rare state to medium well state. An interior brown color with an exterior brown color represents meat in the well done state.

Definitions

As used herein, the term “soy material” is defined as a material derived from whole soybeans which contain no non-soy derived additives. Such additives may, of course, be added to a soy material to provide further functionality or nutrient content in the soy material. The term “soybean” refers to the species Glycine max, Glycine soja, or any species that is sexually cross compatible with Glycine max.

The term “protein content” as used herein, refers to the relative protein content of a soy material as ascertained by A.O.C.S. (American Oil Chemists Society) Official Methods Bc 4-91(1997), Aa 5-91(1997), or Ba 4d-90(1997), each incorporated herein in its entirety by reference, which determine the total nitrogen content of a soy material sample as ammonia, and the protein content as 6.25 times the total nitrogen content of the sample.

The Nitrogen-Ammonia-Protein Modified Kjeldahl Method of A.O.C.S. Methods Bc4-91 (1997), Aa 5-91 (1997), and Ba 4d-90(1997) used in the determination of the protein content may be performed as follows with a soy material sample. From 0.0250-1.750 grams of the soy material are weighed into a standard Kjeldahl flask. A commercially available catalyst mixture of 16.7 grams potassium sulfate, 0.6 grams titanium dioxide, 0.01 grams of copper sulfate, and 0.3 grams of pumice is added to the flask, then 30 milliliters of concentrated sulfuric acid is added to the flask. Boiling stones are added to the mixture, and the sample is digested by heating the sample in a boiling water bath for approximately 45 minutes. The flask should be rotated at least 3 times during the digestion. Three hundred milliliters of water is added to the sample, and the sample is cooled to room temperature. Standardized 0.5N hydrochloric acid and distilled water are added to a distillate receiving flask sufficient to cover the end of a distillation outlet tube at the bottom of the receiving flask. Sodium hydroxide solution is added to the digestion flask in an amount sufficient to make the digestion solution strongly alkaline. The digestion flask is then immediately connected to the distillation outlet tube, the contents of the digestion flask are thoroughly mixed by shaking, and heat is applied to the digestion flask at about a 7.5-min boil rate until at least 150 milliliters of distillate is collected. The contents of the receiving flask are then titrated with 0.25N sodium hydroxide solution using 3 or 4 drops of methyl red indicator solution—0.1% in ethyl alcohol. A blank determination of all the reagents is conducted simultaneously with the sample and similar in all respects, and correction is made for blank determined on the reagents. The moisture content of the ground sample is determined according to the procedure described below (A.O.C.S Official Method Ba 2a-38). The nitrogen content of the sample is determined according to the formula: Nitrogen (%)=1400.67×[[(Normality of standard acid)×(Volume of standard acid used for sample (ml))]−[(Volume of standard base needed to titrate 1 ml of standard acid minus volume of standard base needed to titrate reagent blank carried through method and distilled into 1 ml standard acid (ml))×(Normality of standard base)]−[(Volume of standard base used for the sample (ml))×(Normality of standard base)]]/(Milligrams of sample). The protein content is 6.25 times the nitrogen content of the sample.

The term “moisture content” as used herein refers to the amount of moisture in a material. The moisture content of a material can be determined by A.O.C.S. (American Oil Chemists Society) Method Ba 2a-38 (1997), which is incorporated herein by reference in its entirety. According to the method, the moisture content of a material may be measured by passing a 1000 gram sample of the ground material through a 6×6 riffle divider, available from Seedboro Equipment Co., Chicago, Ill., and reducing the sample size to 100 grams. The 100 gram sample is then immediately placed in an airtight container and weighed. Five grams of the sample (“Sample Weight”) are weighed onto a tared moisture dish (minimum 30 gauge, approximately 50×20 millimeters, with a tight-fitting slip cover−available from Sargent-Welch Co.). The dish containing the sample is placed in a forced draft oven and dried at 130±3° C. for 2 hours. The dish is then removed from the oven, covered immediately, and cooled in a dissector to room temperature. The dish is then weighed to obtain a Dry Weight. Moisture content is calculated according to the formula: Moisture content (%)=100×[(Sample Weight−Dry Weight)/Sample Weight].

The term “weight on a moisture free basis” or “weight on a dry basis” as used herein and as used interchangeably, refers to the weight of a material after it has been dried to completely remove all moisture, e.g. the moisture content of the material is 0%. Specifically, the weight on a moisture free basis of a soy material can be obtained by weighing the soy material after the soy material has been placed in a 45° C. oven until the soy material reaches a constant weight.

The term “soy protein isolate” as used herein is used in the sense conventional to the soy protein industry. Specifically, a soy protein isolate is a soy material having a protein content of at least 90% soy protein on a moisture free basis. “Isolated soy protein”, as used in the art, has the same meaning as “soy protein isolate” as used herein and as used in the art. A soy protein isolate is formed from soybeans by removing the hull and germ of the soybean from the cotyledon, flaking or grinding the cotyledon and removing oil from the flaked or ground cotyledon, separating the soy protein and carbohydrates of the cotyledon from the cotyledon fiber, and subsequently separating the soy protein from the carbohydrates.

The term “soy protein concentrate” as used herein is used in the sense conventional to the soy protein industry. Specifically, a soy protein concentrate is a soy material having a protein content of from 65% up to 90% soy protein on a moisture-free basis. Soy protein concentrate also contains soy cotyledon fiber, typically from 3.5% to 5% soy cotyledon fiber by weight on a moisture-free basis. A soy protein concentrate is formed from soybeans by removing the hull and germ of the soybean from the cotyledon, flaking or grinding the cotyledon and removing oil from the flaked or ground cotyledon, and separating the soy protein and soy cotyledon fiber from the carbohydrates of the cotyledon.

The term “soy protein flour” as used herein, refers to a comminuted form of defatted soybean material, preferably containing less than about 1% oil, formed of particles having a size such that the particles can pass through a No. 100 mesh (U.S. Standard) screen. The soy cake, chips, flakes, meal, or mixture of the materials are comminuted into a soy flour using conventional soy grinding processes. Soy flour has a soy protein content of about 49% to about 65% on a moisture free basis. Preferably the flour is very finely ground, most preferably so that less than about 1% of the flour is retained on a 300 mesh (U.S. Standard) screen.

Rice is a starchy food containing from about 6% to about 10% protein. The term “rice flour” as used herein relates to an inexpensive by-product of rice milling obtained by grinding broken rice. Conventional milling practices produce rice flour composed largely of about 80% carbohydrates. Because of the low concentration of protein in rice and the resulting bulk required to obtain a satisfactory protein intake, infants and children cannot eat a sufficient amount to meet their protein requirements.

The term “starch” as used herein, is intended to include all starches derived from any native source, any of which may be suitable for use herein. A native starch as used herein, is one as it is found in nature. Also suitable are starches derived from a plant obtained by standard breeding techniques including crossbreeding, translocation, inversion, transformation or any other method of gene or chromosome engineering to include variations thereof. In addition, starch derived from a plant grown from artificial mutations and variations of the above generic composition, which may be produced by known standard methods of mutation breeding, are also suitable herein.

Typical sources for the starches are cereals, tubers, roots, legumes and fruits. The native source can be a waxy variety of corn (maize), pea, potato, sweet potato, banana, barley, wheat, rice, oat, sago, amaranth, tapioca (cassaya), arrowroot, canna, and sorghum particularly maize, potato, cassaya, and rice. As used herein, the term “waxy” or “low amylose” is intended to include a starch containing no more than about 10% by weight amylose. Particularly suitable in the invention are those starches which contain no more than about 5% amylose by weight.

The term “gluten free starch” relates to modified tapioca starch, the main ingredient in many of bakery mix products. Gluten free or substantially gluten free starches are made from wheat-, corn-, and tapioca-based starches and are “gluten-free” because they do not contain gluten from wheat, oats, rye or barley—a factor of particular importance for people diagnosed with celiac disease and/or wheat allergies.

The term “wheat flour” relates to a flour obtained from the milling of wheat. The particle size of wheat flour typically is from about 14-120 μm. Wheat flour typically contains from about 11.7 to about 14% protein and from about 3.7 to about 10.9% fiber.

The term “gluten” relates to a protein fraction in wheat flour that possesses a high protein content as well as unique structural and adhesive properties. In its freshly extracted wet state it is known as gum gluten, and when thereafter dried it becomes a free-flowing powder of high protein content and bland taste. It is generally used in food processing in that form.

The term “soy cotyledon fiber” as used herein refers to the fibrous portion of soy cotyledons containing at least 70% fiber (polysaccharide). Soy cotyledon fiber typically contains some minor amounts of soy protein, but may also be 100% fiber. Soy cotyledon fiber, as used herein, does not refer to, or include, soy hull fiber. To avoid confusion the term “fiber” as used herein (except in this paragraph) refers to fiber formed in the process of extruding a soy protein material, generally by protein-protein interactions, not soy cotyledon fiber. To further avoid confusion, soy cotyledon fiber will be referred to herein only as “soy cotyledon fiber” and not as “fiber.” Soy cotyledon fiber is formed from soybeans by removing the hull and germ of the soybean from the cotyledon, flaking or grinding the cotyledon and removing oil from the flaked or ground cotyledon, and separating the soy cotyledon fiber from soy protein and carbohydrates of the cotyledon.

The term “humectant” as used herein refers to moisture retention. Any substance that is added to another substance to keep it moist is a humectant. The addition of a humectant to a foodstuff has the effect of keeping the foodstuff moist. Inhibiting the loss of moisture in a foodstuff keeps the foodstuff both fresh and soft.

The Soy Protein Material (A)

In one embodiment the soy protein material (A) is a soy protein source selected from the group consisting of a soy protein isolate, a soy protein concentrate, a soy protein flour or mixtures of each with the other. If the soy protein source is a mixture, the mixture of soy protein isolate and another soy protein should contain at least about 50% soy protein isolate, by weight of the combined soy protein isolate and the other soy protein, in order to ensure good protein fiber formation in the soy protein material (A). The soy protein material (A) may further comprise components selected from the group consisting of a starch, gluten free starch, rice flour, wheat flour, wheat gluten, soy cotyledon fiber, and mixtures thereof.

In another embodiment, when the soy protein material (A) is an extrusion product of water and a soy protein isolate, on a dry basis, from about 2% to about 20% by weight of a starch or gluten free starch is present along with from about 2% to about 20% by weight of at least one selected from the group consisting of a wheat flour, a wheat gluten, and mixtures thereof, with the remainder being the soy protein isolate.

In another embodiment, when the soy protein material (A) is an extrusion product of water and a soy protein source, on a dry basis, from about 2% to about 20% by weight of at least one selected from the group consisting of a rice flour, a gluten free starch, and mixtures thereof is used, the remainder of the soy protein material (A) is at least one selected from the group consisting of a soy protein isolate, a soy protein concentrate, a soy protein flour, and mixtures thereof.

In another embodiment, when the soy protein material (A) is an extrusion product of water and a soy protein source, on a dry basis, from about 1% to about 20% by weight of a soy cotyledon fiber is used, the remainder of the soy protein material (A) is at least one selected from the group consisting of a soy protein isolate, a soy protein concentrate, a soy protein flour, and mixtures thereof.

In another embodiment, when the soy protein material (A) is an extrusion product of water and a soy protein source, on a dry basis, from about 1% to about 20% by weight of a soy cotyledon fiber and from about 10% to about 50% by weight of a wheat flour or wheat gluten is used, with the remainder selected from the group consisting of a soy protein isolate, a soy protein concentrate, a soy protein flour, and mixtures thereof.

In another embodiment, when the soy protein material (A) is an extrusion product of water and a soy protein source, on a dry basis, from about 1% to about 20% by weight of a soy cotyledon fiber and from about 10% to about 50% by weight of a wheat flour or wheat gluten is used, the soy protein material (A) may also include from about 1% to about 15% by weight of a starch, with the remainder selected from the group consisting of a soy protein isolate, a soy protein concentrate, a soy protein flour, and mixtures thereof.

The soy protein material (A) is produced by extruding one or more of the soy protein isolate, soy protein concentrate and soy protein flour and water or by extruding one or more of the soy protein isolate, soy protein concentrate and soy protein flour and water with one or more of the above named components of a starch, gluten free starch, rice flour, wheat flour and wheat gluten and soy cotyledon fiber. The soy protein material (A) has a moisture content of from about 4% to about 80%. Moisture conditions employed in producing the soy protein material (A) are low moisture soy protein material (A) (about 4% up to less than about 50%) and high moisture soy protein material (A) (at least about 50% up to about 80%). In producing a soy protein material (A), the above ingredients are heated along with water under increasing temperature, pressure and shear conditions in a cooker extruder, and extruding the ingredient mixture through a die. Upon extrusion, the extrudate generally expands to form a fibrous cellular structure as it enters a medium of reduced pressure (usually atmospheric). Extrusion methods for forming fibrous cellular structures are well known and disclosed, for example, in U.S. Pat. No. 4,099,455.

The soy protein content of the soy protein material (A), irrespective of being a low moisture soy protein material (A) or a high moisture soy protein material (A) is from about 30% to about 90% by weight on a moisture free basis. For a low moisture soy protein material (A), the soy protein content, including the moisture, is greater than about 50% up to about 90% by weight. For a high moisture soy protein material (A), the soy protein content, including the moisture, is from about 30% up to about 50% by weight.

The soy protein isolate should not be a highly hydrolyzed soy protein isolate that has a low molecular weight distribution since highly hydrolyzed soy protein isolates lack the protein chain length to properly form protein fibers in the process. Highly hydrolyzed soy protein isolates, however, may be used in combination with other soy protein isolates provided that the highly hydrolyzed soy protein isolate content of the combined soy protein isolates is less than about 40% of the combined soy protein isolates, by weight.

The soy protein isolate utilized should have a water holding capacity sufficient to enable the protein in the isolate to form fibers upon extrusion. The water holding capacity of the soy protein isolate is a measure of the amount of swelling the protein undergoes when hydrated. The swelling of the protein should be sufficient to enable the protein to form intermolecular contacts to permit fiber formation to occur. The soy protein isolate used in the process of the invention preferably has a water holding capacity of at least about 4.0 grams of water per gram of soy protein isolate (as is) at pH 7.0, and more preferably has a water holding capacity of at least about 5.0 grams of water per gram of soy protein isolate (as is) at pH 7.0. The water holding capacity is determined by using the centrifuge method.

Non-highly hydrolyzed soy protein isolates having a water holding capacity of at least about 4.0 grams of water per gram of soy protein isolate that are useful in the present invention are commercially available, for example, from Solae, LLC (St. Louis, Mo.), and include SUPRO® 500E, SUPRO® EX 33, SUPRO® 620, SUPRO® 630 and SUPRO® 545.

Soy protein isolates useful as the soy protein source may be produced from soybeans according to conventional processes in the soy protein manufacturing industry. Exemplary of such a process, whole soybeans are initially detrashed, cracked, dehulled, degermed, and defatted according to conventional processes to form soy flakes, soy flour, soy grits, or soy meal. The soybeans may be detrashed by passing the soybeans through a magnetic separator to remove iron, steel, and other magnetically susceptible objects, followed by shaking the soybeans on progressively smaller meshed screens to remove soil residues, pods, stems, weed seeds, undersized beans, and other trash. The detrashed soybeans may be cracked by passing the soybeans through cracking rolls. Cracking rolls are spiral-cut corrugated cylinders which loosen the hull as the soybeans pass through the rolls and crack the soybean material into several pieces. The cracked soybeans may then be dehulled by aspiration. The dehulled soybeans are degermed by shaking the dehulled soybeans on a screen of sufficiently small mesh size to remove the small sized germ and retain the larger cotyledons of the beans. The cotyledons are then flaked by passing the cotyledons through a flaking roll. The flaked cotyledons are defatted by extracting oil from the flakes by mechanically expelling the oil from the flakes or by contacting the flakes with hexane or other suitable lipophilic/hydrophobic solvent. The defatted flakes may be ground to form a soy flour, a soy grit, or a soy meal, if desired.

The defatted soy flakes, soy flour, soy grits, or soy meal is/are then extracted with an aqueous alkaline solution, typically a dilute aqueous sodium hydroxide solution having a pH of from about 7.5 up to about 11.0, to extract protein soluble in an aqueous alkaline solution from insolubles. The insolubles are soy cotyledon fiber which is composed primarily of insoluble carbohydrates. An aqueous alkaline extract containing the soluble protein is subsequently separated from the insolubles, and the extract is then treated with an acid to lower the pH of the extract to around the isoelectric point of the soy protein, preferably to a pH of from about 4.0 up to about 5.0, and most preferably to a pH of from about 4.4 up to about 4.6. The soy protein precipitates from the acidified extract due to the protein's lack of solubility in an aqueous solution at or near its isoelectric point. The precipitated protein curd is then separated from the remaining extract (whey). The separated protein may be washed with water to remove residual soluble carbohydrates and ash from the protein material. The separated protein is then dried using conventional drying means such as spray drying or tunnel drying to form a soy protein isolate.

Soy protein concentrate may be blended with the soy protein isolate to substitute for a portion of the soy protein isolate present as the soy protein source. Soy protein isolates, in general, have higher water holding capacity and form better fibers than soy protein concentrates. Therefore, the amount of soy protein concentrate substituted for soy protein isolate should be limited to an amount that will permit significant fiber formation in the extrudate. Preferably, if a soy protein concentrate is substituted for a portion of the soy protein isolate, the soy protein concentrate is substituted for up to 40% of the soy protein isolate by weight, at most, and more preferably is substituted for up to 30% of the soy protein isolate by weight.

Soy protein concentrates useful as the soy protein source are commercially available. For example, soy protein concentrates Promine DSPC, Procon, Alpha 12 and Alpha 5800 are available from Solae®, LLC (St. Louis, Mo.). Soy protein concentrates useful in the present invention may also be produced from soybeans according to conventional processes in the soy protein manufacturing industry. For example, defatted soy flakes, soy flour, soy grits, or soy meal produced as described above may be washed with aqueous ethanol (preferably about 60% up to about 80% aqueous ethanol) to remove soluble carbohydrates from the soy protein and soy fiber. The soy protein and soy fiber containing material is subsequently dried to produce the soy protein concentrate. Alternatively, the defatted soy flakes, soy flour, soy grits, or soy meal may be washed with an aqueous acidic wash having a pH of from about 4.3 up to about 4.8 to remove soluble carbohydrates from the soy protein and soy fiber. The soy protein and soy fiber containing material is subsequently dried to produce the soy protein concentrate.

Additional fiber may be present in the soy protein material in the form of a soy cotyledon fiber. The soy cotyledon fiber utilized in the soy protein material should effectively bind water when the mixture of soy protein source and soy cotyledon fiber are co-extruded. By binding water, the soy cotyledon fiber induces a viscosity gradient across the extrudate as the extrudate is extruded through a cooling die, thereby promoting the formation of protein fibers. To effectively bind water for the purposes of the process of the present invention, the soy cotyledon fiber should have a water holding capacity of at least 5.50 grams of water per gram of soy cotyledon fiber, and preferably the soy cotyledon fiber has a water holding capacity of at least 6.0 grams of water per gram of soy cotyledon fiber. It is also preferable that the soy cotyledon fiber has a water holding capacity of at most 8.0 grams of water per gram of soy cotyledon fiber.

The soy cotyledon fiber is a complex carbohydrate and is commercially available. For example, FIBRIM® 1260 and FIBRIM® 2000 are soy cotyledon fiber materials that are commercially available from Solae, LLC (St. Louis, Mo.) that work well in the present invention. Soy cotyledon fiber useful in the present invention may also be produced according to conventional processes in the soy processing industry. For example, defatted soy flakes, soy flour, soy grits, or soy meal produced as described above may be extracted with an aqueous alkaline solution as described above with respect to the production of a soy protein isolate to separate the insoluble soy cotyledon fiber from the aqueous alkaline soluble soy protein and carbohydrates. The separated soy cotyledon fiber is then dried, preferably by spray drying, to produce a soy cotyledon fiber product. Soy cotyledon fiber is generally present in the soy protein material at from about 1% up to about 20%, preferably at from about 1.5% up to about 15% and most preferably at from about 2% up to about 10% by weight on a moisture free basis.

A modest concentration of soy fiber is believed to be effective in obstructing cross-linking of protein molecules, thus preventing excessive gel strength from developing in the cooked extrusion mass exiting the die. Unlike the protein, which also absorbs moisture, soy fiber readily releases moisture upon release of pressure at the die exit temperature.

Wheat flour, wheat gluten or mixtures thereof may be used as an ingredient to be mixed and extruded with the soy protein source and soy cotyledon fiber. Wheat gluten provides an economical source of protein, and may be substituted for a portion of the soy protein source. The protein of wheat gluten has a very low water holding capacity and is ineffective to form significant protein fibers by itself upon extrusion. Therefore, the amount of wheat gluten in the mixture of soy protein source, soy cotyledon fiber, and other ingredients should be limited to less than about 60% of the mixture on a dry ingredient basis. Preferably wheat gluten is present in the soy protein material (A) at from about 10% up to about 50% by weight on a moisture free basis, preferably at from about 12% up to about 45% by weight on a moisture free basis, and most preferably at from about 15% up to about 40% by weight on a moisture free basis. Wheat gluten is a commercially available ingredient. A preferred commercially available wheat gluten useful in the present invention is Gem of the Star Gluten, available from Manildra Milling.

A starch material may also be used as an ingredient to be mixed and extruded with the soy protein material and soy cotyledon fiber. Starch may be used to provide texture to the fibrous material produced by extruding the soy protein material, soy cotyledon fiber, starch, and other ingredients. The starch material used is preferably a naturally occurring starch. The starch material may be isolated from a variety of plants such as corn, wheat, potato, rice, arrowroot, and cassaya by well-known, conventional methods. Starch materials useful in the process of the present invention include the following commercially available starches: coin, wheat, potato, rice, high amylose corn, waxy maize, arrowroot, and tapioca. Preferably the starch material used is a corn starch or a wheat starch, and most preferably is a commercially available dent corn starch or native wheat starch. The starch is present in the soy protein material (A) at from about 1% up to about 15% by weight on a moisture free basis, preferably at from about 2% up to about 12% by weight on a moisture free basis, and most preferably at from about 5% up to about 10% by weight on a moisture free basis. A preferred dent corn starch is commercially available from A. E. Staley Mfg., Co. sold as Dent Corn Starch, Type IV, Pearl.

Preferably, flavor ingredients are also mixed and extruded with the soy protein material and the soy cotyledon fiber. The preferred flavor ingredients are those that provide a meat-like flavor to the fibrous material produced by extruding the soy protein material and soy cotyledon fiber. Preferred flavor ingredients include beef flavor, chicken flavor, grill flavor, and malt extract, all commercially available from flavor ingredient manufacturers.

A suitable extrusion process for the preparation of a low moisture soy protein material (A) comprises introducing the particular ingredients of the soy protein source, soy cotyledon fiber, wheat gluten and starch formulation into a mixing tank (i.e., an ingredient blender) to combine the ingredients and form a dry blended soy protein material pre-mix. The dry blended soy protein material pre-mix is then transferred to a hopper from which the dry blended ingredients are introduced into a pre-conditioner to form a conditioned fibrous material mixture. The conditioned soy protein material is then fed to an extrusion apparatus (i.e., extruder) in which the soy protein material mixture is heated under mechanical pressure generated by the screws of the extruder to form a molten extrusion mass. The molten extrusion mass exits the extruder through an extrusion die.

In the pre-conditioner, the particulate solid ingredient mix is preheated, contacted with moisture, and held under controlled temperature and pressure conditions to allow the moisture to penetrate and soften the individual particles. The preconditioning step increases the bulk density of the particulate soy protein material mixture and improves its flow characteristics. The preconditioner contains one or more paddles to promote uniform mixing of the protein and transfer of the protein mixture through the preconditioner. The configuration and rotational speed of the paddles vary widely, depending on the capacity of the preconditioner, the extruder throughput and/or the desired residence time of the fibrous material mixture in the preconditioner or extruder barrel. Generally, the speed of the paddles is from about 500 to about 1300 revolutions per minute (rpm).

Typically, the soy protein material mixture is pre-conditioned prior to introduction into the extrusion apparatus by contacting the pre-mix with moisture (i.e., steam and/or water) at a temperature of at least about 45° C. (110° F.). It has been observed, however, that higher temperatures (i.e., temperatures above 85° C. (185° F.)) in the preconditioner may encourage starches to gelatinize, which in turn may cause lumps to form, which may impede flow of the protein mixture from the preconditioner to the extruder barrel.

Typically, the soy protein material pre-mix is conditioned for a period of about 30 to about 60 seconds, depending on the speed and the size of the conditioner. The soy protein material pre-mix is contacted with steam and/or water and heated in the pre-conditioner at generally constant steam flow to achieve the desired temperatures. The water and/or steam conditions (i.e., hydrates) the soy protein material mixture, increases its density, and facilitates the flowability of the dried mix without interference prior to introduction to the extruder barrel where the proteins are texturized.

The conditioned pre-mix may contain from about 5% to about 30% (by weight) water. The conditioned pre-mix typically has a bulk density of from about 0.25 g/cm³ to about 0.6 g/cm³. Generally, as the bulk density of the pre-conditioned protein mixture increases within this range, the protein mixture is easier to process. This is presently believed to be due to such mixtures occupying all or a majority of the space between the screws of the extruder, thereby facilitating conveying the extrusion mass through the barrel.

The conditioned pre-mix is generally introduced to the extrusion apparatus at a rate of no more than about 10 kilograms (kg)/min (no more than about 20 lbs/min). Generally, it has been observed that the density of the extrudate decreases as the protein rate of pre-mix to the extruder increases.

Extrusion devices have long been used in the manufacture of a wide variety of edible products. One suitable extrusion device is a double-barrel, twin screw extruder as described, for example, in U.S. Pat. No. 4,600,311. Examples of commercially available double-barrel, twin screw extrusion apparatus include a CLEXTRAL Model BC-72 extruder manufactured by Clextral, Inc. (Tampa, Fla.); a WENGER Model TX-57 extruder manufactured by Wenger (Sabetha, Kans.); and a WENGER Model TX-52 extruder manufactured by Wenger (Sabetha, Kans.). Other conventional extruders suitable for use in this invention are described, for example, in U.S. Pat. Nos. 4,763,569, 4,118,164, and 3,117,006, which are incorporated by reference.

The screws of a twin screw extruder can rotate within the barrel in the same or opposite directions. Rotation of the screws in the same direction is referred to as single flow whereas rotation of the screws in opposite directions is referred to as double flow. The speed of the screw or screws of the extruder may vary depending on the particular apparatus. However, the screw speed is typically from about 250 to about 350 revolutions per minute (rpm). Generally, as the screw speed increases, the density of the extrudate decreases.

The extrusion apparatus generally comprises a plurality of heating zones through which the protein mixture is conveyed under mechanical pressure prior to exiting the extrusion apparatus through an extrusion die. The temperature in each successive heating zone generally exceeds the temperature of the previous heating zone by between about 10° C. and about 70° C. (between about 15° F. and about 125° F.). In one embodiment, the conditioned pre-mix is transferred through four heating zones within the extrusion apparatus, with the protein mixture heated to a temperature of from about 100° C. to about 150° C. (from about 212° F. to about 302° F.) such that the molten extrusion mass enters the extrusion die at a temperature of from about 100° C. to about 15020 C. (from about 212° F. to about 302° F.).

The pressure within the extruder barrel is not narrowly critical. Typically the extrusion mass is subjected to a pressure of at least about 400 psig (about 28 bar) and generally the pressure within the last two heating zones is from about 1000 psig to about 3000 psig (from about 70 bar to about 210 bar). The barrel pressure is dependent on numerous factors including, for example, the extruder screw speed, feed rate of the mixture to the barrel, feed rate of water to the barrel, and the viscosity of the molten mass within the barrel.

Water is injected into the extruder barrel to hydrate the soy protein material mixture and promote texturization of the proteins. As an aid in forming the molten extrusion mass the water may act as a plasticizing agent. Water may be introduced to the extruder barrel via one or more injection jets in communication with a heating zone. Typically, the mixture in the barrel contains from about 15% to about 30% by weight water. The rate of introduction of water to any of the heating zones is generally controlled to promote production of an extrudate having desired characteristics. It has been observed that as the rate of introduction of water to the barrel decreases, the density of the extrudate decreases. Typically, less than about 1 kg of water per kg of protein is introduced to the barrel. Generally, from about 0.1 kg to about 1 kg of water per kg of protein are introduced to the barrel.

The molten extrusion mass in the extrusion apparatus is extruded through a die to produce an extrudate, which may then dried in a dryer.

Extrusion conditions are generally such that the product emerging from the extruder barrel typically has a moisture content of from about 20% to about 45% (by weight) wet basis. The moisture content is derived from water present in the mixture introduced to the extruder, moisture added during preconditioning and/or any water injected into the extruder barrel during processing.

Upon release of pressure, the molten extrusion mass exits the extruder barrel through the die, superheated water present in the mass flashes off as steam, causing simultaneous expansion (i.e., puffing) of the material. The level of expansion of the extrudate upon exiting of the mixture from the extruder in terms of the ratio of the cross-sectional area of extrudate to the cross-sectional area of die openings is generally less than about 15:1. Typically, the ratio of the cross-sectional area of extrudate to the cross-sectional area of die openings is from about 2:1 to about 11:1.

The extrudate is cut after exiting the die. Suitable apparatus for cutting the extrudate include flexible knives manufactured by Wenger (Sabetha, Kans.) and Clextral (Tampa, Fla.). As the extrudate exits the die, the extrudate may be cut in varying sizes. The extrudate is cylindrical in shape. The cutting interval may be small, such that the extrudate is in the shape of pennies or the cutting interval may be increased to about 5 cm such that the cut extrudate resembles a raw potato in miniature. Further, the potato shaped extrudate may also be cut into thin strips or small, match-like pieces.

The dryer, if one is used for the low moisture soy protein material, to dry the extrudates generally comprises a plurality of drying zones in which the air temperature may vary. Generally, the temperature of the air within one or more of the zones will be from about 135° C. to about 185° C. (from about 280° F. to about 370° F.). Typically, the extrudate is present in the dryer for a time sufficient to provide an extrudate having a desired moisture content. This desired moisture content may vary widely depending on the intended application of the extrudate and, generally, is from 4% up to less than about 50% by weight. In one embodiment, the moisture content is from about 4% up to about 13% by weight. In another embodiment, the moisture is from about 16% up to about 30% by weight. Generally, the extrudate is dried for at least about 5 minutes and, more generally, for at least about 10 minutes. Suitable dryers include those manufactured by Wolverine Proctor & Schwartz (Merrimac, Mass.), National Drying Machinery Co. (Philadelphia, Pa.), Wenger (Sabetha, Kans.), Clextral (Tampa, Fla.), and Buehler (Lake Bluff, Ill.).

The dried extrudates may further be comminuted to reduce the average particle size of the extrudate. Suitable grinding apparatus include hammer mills such as Mikro Hammer Mills manufactured by Hosokawa Micron Ltd. (England).

Prior to combining the low moisture soy protein material (A) with the humectant (B), the low moisture soy protein material having a moisture content of from 4% to 13% by weight, when dried, needs to be hydrated in water until the water is absorbed. If the low moisture soy protein material is not completely dried, its moisture content is higher, generally from 16% to 30% by weight. The non completely dried low moisture soy protein material needs to be hydrated prior to combining with the humectant. However, when a non completely dried low moisture soy protein material is used, less water is necessary for hydrating the non completely dried low moisture soy protein material and hydration of the non completely dried low moisture soy protein material occurs much faster. The low moisture soy protein material is hydrated either until water is absorbed with the fibers remaining intact or until water is absorbed and the fibers are separated.

The ingredients employed to make a low moisture soy protein material of from about 4% up to less than about 50% by weight are also used to make a high moisture soy protein material of from at least about 50% up to about 80% by weight. The soy protein source, soy cotyledon fiber and other ingredients are dry blended and mixed in a mixing tank to combine the ingredients and form a dry blended soy protein material pre-mix. Alternatively, the soy protein source, soy cotyledon fiber and other ingredients may be mixed directly with water to form a dough, without being dry blended first, preferably in a preconditioner.

Preferably the dough mixture including the dry ingredients and the water is conditioned for extrusion in the preconditioner by heating the dough mixture. Preferably the dough mixture is heated to a temperature of from 50° C. to 80° C., more preferably from 60° C. to 75° C. in the preconditioner.

The dough mixture is then fed into a cooking extruder to heat, shear, and, ultimately, to plasticize the dough mixture. The cooking extruder may be selected from commercially available cooking extruders. Preferably the cooking extruder is a single screw extruder, or more preferably a twin screw extruder, that mechanically shears the dough with the screw elements. Commercially available cooking extruders useful in the practice of the present invention include Clextral extruders, commercially available from Clextral, Inc., Tampa, Fla.; Wenger extruders, commercially available from Wenger, Inc, Sabetha, Kans.; and Evolum extruders, commercially available from Clextral, Inc. A particularly preferred cooking extruder for the practice of the present invention is a Clextral BC72 cooking extruder, available from Clextal, Inc. Another preferred cooking extruder for the practice of the present invention is an EV32 twin screw extruder from Evolum.

The dough mixture is subjected to shear and pressure by the cooking extruder to plasticize the dough mixture. The screw elements of the cooking extruder shear the dough mixture as well as create pressure in the extruder by forcing the dough mixture forward though the extruder and through the die. The screw motor speed determines the amount of shear and pressure applied to the dough mixture by the screw(s). Preferably the screw motor speed is set to a speed of from 200 rpm to 500 rpm, and more preferably from 300 rpm to 400 rpm, which moves the dough mixture through the extruder at a rate of at least 20 kilograms per hour, and more preferably at least 40 kilograms per hour. Preferably the cooking extruder generates an extruder barrel exit pressure of from 500 to 1500 psig, and more preferably an extruder barrel exit pressure of from 600 to 1000 psig is generated.

The dough mixture is heated by the cooking extruder as it passes through the extruder. Heating denatures the protein in the dough mixture enabling the dough mixture to plasticize. The cooking extruder includes a means for heating the dough mixture to temperatures of from 100° C. to 180° C. Preferably the means for heating the dough mixture in the cooking extruder comprises extruder barrel jackets into which heating or cooling media such as steam or water may be introduced to control the temperature of the dough mixture passing through the extruder. The cooking extruder may also include steam injection ports for directly injecting steam into the dough mixture within the extruder. The cooking extruder preferably includes multiple heating zones that can be controlled to independent temperatures, where the temperatures of the heating zones are preferably set to increase the temperature of the dough mixture as the dough mixture proceeds through the extruder. For example, the cooking extruder may be set in a four temperature zone arrangement, where the first zone (adjacent the extruder inlet port) is set to a temperature of from 80° C. to 100° C., the second zone is set to a temperature of from 100° C. to 135° C., the third zone is set to a temperature of from 135° C. to 150° C., and the fourth zone (adjacent the extruder exit port) is set to a temperature of from 150° C. to 180° C. The cooking extruder may be set in other temperature zone arrangements, as desired. For example, the cooking extruder may be set in a five temperature zone arrangement, where the first zone is set to a temperature of 25° C., the second zone is set to a temperature of 50° C., the third zone is set to a temperature of 95° C., the fourth zone is set to a temperature of 130° C., and the fifth zone is set to a temperature of 150° C.

A long cooling die is attached to the cooking extruder so the plasticized dough mixture flows from the extruder through the cooling die upon exiting the extruder exit port. The dough mixture forms a melted plasticized mass in the cooking extruder that flows from the cooking extruder into the die. The cooling die cools and shapes the hot dough mixture as it exits cooking extruder. Fiber formation is induced in the plasticized dough mixture by the cooling effect of the cooling die to form a fibrous soy protein material. The fibrous soy protein material exits the cooling die through at least one aperture in the die face, which may be a die plate affixed to the die. The fibrous soy protein material extrudate is cut into desired lengths with a cutting knife positioned adjacent the die aperture(s) to cut the extrudate as it exits the die aperture(s).

The cooling die is maintained at a temperature significantly cooler than the temperature in the cooking extruder in the final temperature zone of the extruder adjacent the die. The cooling die includes means for maintaining the temperature at a temperature significantly cooler than the exit temperature of the cooking extruder. Preferably the cooling die includes inlet and outlet ports for circulating media for maintaining the die temperature. Most preferably, constant temperature water is circulated through the cooling die as the circulating media for maintaining the desired die temperature. Preferably, the cooling die is maintained at a temperature of from 80° C. to 110° C., more preferably the cooling die is maintained at a temperature of from 85° C. to 105° C., and most preferably the cooling die is maintained at a temperature of from 90° C. to 100° C.

The cooling die is preferably a long cooling die to ensure that the plasticized dough material is cooled sufficiently in transit through the die to induce proper fiber formation. In a preferred embodiment, the die is at least 200 millimeters long, and more preferably is at least 500 millimeters long. Long cooling dies useful in the practice of the process of the present invention are commercially available, for example from Clextral, Inc., E.I. duPont de Nemours and Company, and Kobe Steel, Ltd.

The width and height dimensions of the cooling die aperture(s) are selected and set prior to extrusion of the dough mixture to provide the fibrous soy protein material extrudate with the desired dimensions. The width of the die aperture(s) may be set so that the extrudate resembles from a cubic chunk of meat to a steak filet, where widening the width of the die aperture(s) decreases the cubic chunk-like nature of the extrudate and increases the filet-like nature of the extrudate. Preferably the width of the cooling die aperture(s) is/are set to a width of from 10 millimeters to 40 millimeters, and most preferably from 25 millimeters to 30 millimeters.

The height dimension of the cooling die aperture(s) may be set to provide the desired thickness of the extrudate. The height of the aperture(s) may be set to provide a very thin extrudate or a thick extrudate. A novel feature of the present invention is that the height of the aperture(s) may be set to at least 12 millimeters, and the resulting extrudate is fibrous across the entirety of any cross-section of the extrudate. Prior to the present invention, high moisture extrudates having a thickness of at least 12 millimeters (as determined by the height of the cooling die aperture(s)) gelled in the center of the extrudate, and were not fibrous across the entirety of a transverse cross-section of the extrudate. Preferably, the height of the cooling die aperture(s) may be set to from 1 millimeter to 30 millimeters, and more preferably from 12 millimeters to 25 millimeters, and most preferably from 15 millimeters to 20 millimeters.

Due to the high moisture content of the dough mixture, little dissipation of energy and expansion occurs in the fibrous material extrudate as it exits the die aperture(s). As a result, the fibrous material is relatively dense compared to a low moisture extrudate, since few air vacuoles are introduced into the fibrous material extrudate by expansion of the extrudate upon extrusion from the die.

Prior to combining the high moisture fibrous soy protein material (A) with the humectant (B), the high moisture fibrous soy protein material (A) having a moisture content of from 50% to 80% by weight, needs to be hydrated in water until the water is absorbed. The high moisture fibrous soy protein material is hydrated either until water is absorbed with the fibers remaining intact or until water is absorbed and the fibers are separated.

One example of a fibrous material containing soy protein and soy cotyledon fiber for use in the restructured meat product described herein is FXP MO339, available from The Solae Co. (St. Louis, Mo.). FXP MO339 is an extruded dry textured soy protein product with suitable fibrosity and texture, and a suitable amount of soy protein. Specifically, FXP MO339 comprises about 70% by weight soy protein, about 2% by weight of fiber, about 23% by weight of wheat gluten, about 9% by weight of starch and about 10% by weight moisture. Another example of a fibrous material containing soy protein and soy cotyledon fiber for use in the restructured meat product described herein is VETEX 1000, available from Stentorian Industries Company Limited (Taiwan). A third example of a fibrous material containing soy protein and soy cotyledon fiber for use in the restructured meat product described herein is FXP MO327, available from The Solae Co. (St. Louis, Mo.). FXP MO327 is an extruded dry textured soy protein product with suitable fibrosity and texture, and a suitable amount of soy protein. Specifically, FXP MO327 comprises about 30% by weight soy protein, about 1% by weight of fiber, about 17% by weight of wheat gluten, about 1% by weight of starch and about 60% by weight moisture.

(B) The Humectant

Component (B) is a humectant. The humectant (B) is a substance that functions to absorb and/or promote the retention of moisture. In the present invention, the humectant comprises (i) a colorant and at least one of (ii) a flavoring agent, (iii) a triglyceride oil, (iv) a food grade acid or acidic salt, (v) a food grade base or basic salt, or (vi) a food grade emulsion is employed. Preferably more than two humectants are employed.

The colorant (i) provides eye appeal to the soy protein containing food product. This food product is distinguished in having coloration similar to the various colors of meat in both the uncooked state and the various cooked states. In the uncooked state, the product, both interior and exterior is a red color. In the cooked states, the interior color of the product, is a red, reddish-brown or brown color and the exterior color is brown. A red interior color with a brown exterior color indicates a product resembling a piece of meat in the rare state. An interior reddish-brown color of varying degrees of redness (from red to pinkish-brown with an exterior color of brown) represents meat in the medium rare state to medium well state. An interior brown color with an exterior brown color represents meat in the well done state.

Colorants provide a red color to the restructured meat product in the uncooked state, as well as a brown color in the cooked state. Examples of colorants are edible colorings such as caramel color, paprika, cinnamon beet powder, carmine, water soluble annatto, turmeric, saffron and FD & C (Food, Drug and Cosmetic) Red No. 3 (A.K.A. Food Red 14 and Erythrosine BS), FD & C Yellow No. 5 (A.K.A. Food Yellow 4 and Tartrazine), FD & C Yellow No. 6 (A.K.A. Food Yellow 3 and Sunset Yellow FCF), FD & C Green No. 3 (A.K.A. Food Green 3 and Fast Green FCF), FD & C Blue No. 2 (A.K.A. Food Blue I and Indigo Carmine), FD & C Blue No. 1 (A.K.A. Food Blue 2 and Brilliant Blue FCF), FD & C Violet No. 1 (A.K.A. Food Violet 2 and Violet B6) and combinations thereof. Sodium nitrite, which also functions as a curing agent, is the colorant of choice when meat in the form of a red meat such as beef is present. Titanium dioxide is the colorant of choice when meat in the form of a non-red meat such as chicken, turkey or pork is present. Preferred is caramel and carmine, which can come in various color ranges.

In using caramel and carmine, caramel provides a brown color and carmine provides a red color to the soy protein containing food product. Adjusting these two colorants provides a soy protein food product that when cooked and compared to a steak appears rare, medium rare, medium well done and well done depending upon the colorants used and the amounts of colorants used. It is noted that carmine is an internal color and the caramel is the external color.

By caramel it is meant an amorphous, dark brown, deliquescent powder or a thick liquid having a bitter taste, a burnt sugar odor and a specific gravity of approximately 1.35. It is soluble in water and dilute alcohol. Caramel is prepared by the careful, controlled heat treatment of carbohydrate or saccharide materials such as dextrose, invert sugar, lactose, malt syrup, molasses, sucrose, starch hydrolysates and fractions thereof. Other materials which may be employed during heat treatment to assist caramelization include acids (e.g. acetic acid, citric acid, phosphoric acid, sulfuric acid and sulfurous acid); and salts (e.g. ammonium, sodium or potassium carbonates, bicarbonates, dibasic phosphates or mono-basic phosphates).

In one process of manufacturing caramel described in U.S. Pat. No. 3,733,405, a liquid sugar, either cane or corn, is pumped into a reactor vessel along with one or a combination of the reagents authorized by the U.S. Food and Drug Administration and the mixture is heated. Temperatures ranging from 250° C. to 500° C. are maintained and the product is held between 15 and 250 pounds per square inch pressure (psi) while the polymerization takes place. When processing is completed the product is discharged to a flash cooler which drops the temperature to 150° F. It is then filtered, cooled and pumped to storage.

It is preferred that the colorant be present in the soy protein containing food product in the range between 0.1% to 5%, preferably in the range of from 0.2% to 4% and most preferably in the range of from 0.5% to 0.2% by weight of the soy protein containing food product.

The flavoring agent (ii) provides a flavorful taste to the soy protein containing food product. Flavoring agents typically are stocks that include but are not limited to basic bouillons, such as beef stock, lobster stock, chicken stock, fish stock, vegetable stock, and the like. Other flavoring agents are seasonings, herbs, spices, pepper, onion powder, garlic powder, savory powders, extracts of mushrooms and natural flavoring extracts (NFE). The flavoring agent enhances the richness of the taste of the soy protein containing food product. The flavoring agent causes the taste of the soy protein containing food product to last longer in the mouth, i.e., a lingering taste effect. The flavoring agent, when employed, is generally present at from 4% to 15% by weight, preferably at from 5% to 12% by weight, on a moisture free basis and most preferably at from 6% to 10% by weight, on a moisture free basis.

The triglyceride oil (iii) employed comprises a vegetable oil triglyceride, a genetically modified vegetable oil triglyceride or a synthetic triglyceride oil of the formula 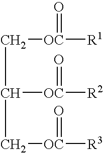
wherein R¹, R² and R³ are aliphatic groups that contain from about 7 up to about 23 carbon atoms;

The aliphatic groups are alkyl groups such as heptyl, nonyl, decyl, undecyl, tridecyl, heptadecyl, and octyl; alkenyl groups containing a single double bond such as heptenyl, nonenyl, undecenyl, tridecenyl, heptadecenyl, heneicosenyl; alkenyl groups containing 2 or 3 double bonds such as 8,11-heptadecadienyl and 8,11,14-heptadecatrienyl, and alkynyl groups containing triple bonds. All isomers of these are included, but straight chain groups are preferred.

All triglyceride oils contain varying amounts of saturated, monounsatu-ated or polyunsaturated character. Genetically modified vegetable oil triglycerides can be prepared with a high (greater than 60 or 70 or even 80%) monounsaturated character at the expense of having a low saturated and low polyunsaturated character.

Oils can be prepared with any amount of saturated, monounsaturated or polyunsaturated character. That is, a synthetic triglyceride oil may be synthesized to contain 100% saturated, or 100% monounsaturated or 100% polyunsaturated character. A synthetic triglyceride oil can be synthesized to have whatever monounsaturated character is desired.

Regular vegetable oil triglycerides (non-genetically modified) have a wide variety of saturated, monounsaturated or polyunsaturated character as shown in the below table.

| | Character | | |
|---|---|---|---|
| Oil | Saturated | Monounsaturated | Polyunsaturated |
| Peanut | 22% | 49% | 29% |
| Rapeseed | 7 | 63 | 30 |
| Soybean | 15 | 23 | 62 |
| Olive | 15 | 75 | 10 |
| Sunflower | 13 | 22 | 65 |
| Palm kernel | 83 | 15 | 2 |
| Corn | 15 | 26 | 59 |
| Coconut | 92 | 5 | 3 |
| Palm | 50 | 40 | 10 |

The preferred vegetable oil triglycerides have a saturated character of less than 30% to ensure that the oil is in liquid form at room temperature. The preferred vegetable oil triglycerides are peanut oil, canola oil, rapeseed oil, soybean oil, olive oil, sunflower oil and corn oil. Canola oil is a variety of rapeseed oil containing less than 1% erucic acid. The most preferred vegetable oil triglyceride is sunflower oil.

The synthetic triglycerides are those formed by the reaction of one mole of glycerol with three moles of a fatty acid or mixture of fatty acids.

Genetically modified vegetable oil triglycerides are prepared from oil seeds that have been genetically modified to produce a higher than normal monounsaturated character. For a genetically modified vegetable oil triglyceride, the fatty acid moieties are such that the triglyceride oil has a monounsaturated character of at least 60 percent, preferably at least 70 percent and most preferably at least 80 percent. These genetically modified vegetable oil triglycerides are produced by plants that contain a higher than normal oleic acid content. Normal sunflower oil has an oleic acid content of 18-40 percent. By genetically modifying the sunflower seeds, a sunflower oil can be obtained wherein the oleic content is from about 60 percent up to about 92 percent. That is, the R¹, R² and R³ groups are heptadecenyl groups and the R¹COO⁻—, R²COO⁻, and R³COO⁻— that are attached to the 1,2,3-propanetriyl group —CH₂CHCH₂— are the residue of an oleic acid molecule. U.S. Pat. Nos. 4,627,192 and 4,743,402 are herein incorporated by reference for their disclosure to the preparation of high oleic sunflower oil.

A triglyceride oil, regardless of its source, comprised exclusively of an oleic acid moiety has an oleic acid content of 100% and consequently a monounsaturated character of 100%. Where the triglyceride is made up of acid moieties that are 70% oleic acid, 10% stearic acid, 13% palmitic acid, and 7% linoleic, the saturated character is 23%, the monounsaturated character is 70% and the polyunsaturated character is 7%. The preferred genetically modified vegetable oil triglycerides are high oleic acid (at least 60 percent) vegetable oil triglycerides. Typical genetically modified high oleic vegetable oil triglycerides employed within the instant invention are high oleic peanut oil, high oleic corn oil, high oleic sunflower oil, and high oleic soybean oil. A preferred genetically modified high oleic vegetable oil is genetically modified high oleic sunflower oil obtained from Helianthus sp. This product is available from A. C. Humko Corporation, Memphis, Tenn. as Sunyl® high oleic sunflower oil. Sunyl 100 oil is a genetically modified high oleic vegetable oil triglyceride wherein the acid moieties comprise at least 85 percent oleic acid.

It is to be noted the olive oil and rapeseed oil are excluded as a genetically modified vegetable oil triglyceride (C) in this invention. The oleic acid content of olive oil typically ranges from 65-85 percent and rapeseed oil is about 63 percent. These monounsaturated contents, however, are not achieved through genetic modification, but rather are naturally occurring.

It is further to be noted that genetically modified vegetable oil triglycerides have high oleic acid contents at the expense of the di- and tri-unsaturated acids. A normal sunflower oil has from 20-40 percent oleic acid moieties and from 50-70 percent linoleic acid moieties. This gives a 90 percent character of mono- and di-unsaturated acid moieties (20+70) or (40+50). Genetically modifying vegetable oil triglycerides generate a low di- or tri-unsaturated moiety vegetable oil triglyceride. The genetically modified vegetable oil triglycerides of this invention have an oleic acid moiety:linoleic acid moiety ratio of from about 2 up to about 90. A 60 percent oleic acid moiety character and 30 percent linoleic acid moiety character of a triglyceride oil gives a ratio of 2. A triglyceride oil made up of an 80 percent oleic acid moiety and 10 percent linoleic acid moiety gives a ratio of 8. A triglyceride oil made up of a 90 percent oleic acid moiety and 1 percent linoleic acid moiety gives a ratio of 90. The ratio for normal sunflower oil is about 0.5 (30 percent oleic acid moiety and 60 percent linoleic acid moiety).

The preferred triglyceride oils are vegetable oil triglycerides and genetically modified vegetable oil triglycerides.

The food grade acid or acidic salt (iv) comprises acetic acid, hydrochloric acid phosphoric acid and their salts of sodium acetate and the sodium phosphates. The food grade acid or acidic salt functions as a pH modifier to adjust the water holding capacity (WHC). A lower pH gives a product with a smaller WHC which changes the texture of the soy protein food product. A lower pH gives a product with a smaller WHC thus making the product more film. The food grade acid or acidic salts are especially useful when the soy protein containing food product further comprises meat. At this point, the food grade acid or acidic salt functions as a curing agent. The sodium chloride and sodium phosphates are salts that are mixed into the soy protein containing food product to extract/solubilize myfibriller protein in the meat. These salts, in addition to being flavor enhancers, also help to bind the meat protein within the soy protein containing food product. These salts, when employed, are generally present at from 0.1% to 4.0% by weight, preferably at from 0.5% to 2.0% by weight, on a moisture free basis and most preferably at from 0.2% to 0.5% by weight, on a moisture free basis.

The food grade base or basic salt (v) comprises sodium carbonate and sodium bicarbonate. The food grade base or basic salt functions as a pH modifier to adjust the water holding capacity (WHC). A higher pH gives a product with an increased WHC which changes the texture of the soy protein food product. A higher pH gives a product with a larger WHC thus making the product less firm. The food grade base or basic salt, when employed, is generally present at from 0.1% to 4.0% by weight, on a moisture free basis, preferably at from 0.5% to 2.0% by weight, on a moisture free basis and most preferably at from 0.2% to 0.5% by weight, on a moisture free basis.

The food grade emulsion (vi) is the combination of two dissimilar liquids, a fat or an oil and water. The use of an emulsifying agent causes a colloidal dispersion to form. The oil provides an oil-in-water stable emulsion. The term “oil-in-water emulsion” refers to emulsions wherein a discontinuous phase is dispersed within a continuous phase. The oil is the discontinuous phase and water is the continuous phase. The emulsifying agent is a soy protein material.

Prior to hydration of the fibrous material (A), the weight ratio of fibrous material (A) on a moisture free basis to the humectant (B) on a moisture free basis is generally from 1-10 to 1, preferably from 1-6 to 1 and most preferably from 1-3 to 1. The hydrated fibrous material and the humectant are combined in a mixing device and mixed to give a precursor to the homogeneous soy protein containing food product.

Water (C)

Employed as water (C), is tap water, distilled water or deionized water. The purpose of the water is to hydrate the soy protein material (A) such that the fibers contained within the soy protein material become separated. Typically, the ratio of soy protein material (A) on a moisture free basis to the hydration water (C) is from 1 to 2-10, preferably from 1 to 2-7 and most preferably from 1 to 2-5. More water for hydration is employed when a low moisture soy protein material is utilized. Less water for hydration is employed when a high moisture soy protein material is utilized. The temperature of the water may range from 0° C. up to 100° C. Hydration time may be from 10 minutes up to several hours, depending upon the moisture content of the fibrous material, the amount of water utilized and the temperature of the water. The total amount of water employed need not be added at once. The soy protein material needs to be at least partially hydrated. As the remaining ingredients are added, additional water may be employed.

At a minimum, the soy protein containing food product comprises
(A) a soy protein material selected from the group consisting of a soy protein flour, a soy protein concentrate, a soy protein isolate and mixtures thereof;
(B) a humectant comprising
   (i) a colorant and at least one selected from the group consisting of
   (ii) a flavoring agent,
   (iii) a triglyceride,
   (iv) a food grade acid or acidic salt,
   (v) a food grade base or basic salt, and
   (vi) a food grade emulsion; and
(C) water.

The soy protein containing food product is prepared by a process comprising the steps of; hydrating
(A) a soy protein material selected from the group consisting of a soy protein flour, a soy protein concentrate, a soy protein isolate and mixtures thereof until the water is absorbed; and adding
(B) a humectant comprising
   (i) a colorant and at least one selected from the group consisting of
   (ii) a flavoring agent,
   (iii) a triglyceride,
   (iv) a food grade acid or acidic salt,
   (v) a food grade base or basic salt, and
   (vi) a food grade emulsion; and
      mixing the hydrated soy protein material and the humectant to produce a homogenous fibrous and texturized soy protein containing food product having a moisture content of at least about 50%.

The product and process of this invention are completed by combining Components (A), (B) and (C) as per the disclosed ratios of (A):(B) and (A):(C). The soy protein material (A) is first hydrated with water (C). When hydration is complete, the humectant (B) is added and the contents are mixed until a homogeneours mass of a soy protein containing food product is obtained. At this point, the soy protein containing food product may be formed into strips, steaks, cutlets or patties, either by hand or by machine. The soy protein containing food product may also be stuffed into permeable or impermeable casings.

The above-described soy protein containing food product and the process for its preparation is meat-free and consequently is of value to those who for religious or health reasons choose to avoid meat products.

For those who choose to consume meat and meat products, the soy protein containing food product and the process for its preparation may also further comprise a meat and an animal fat. The meat is selected from the group consisting of beef, pork, lamb, turkey and chicken. The term “meat” as used herein includes not only animal tissue (such as would be recognized as “meat” by the layman, particularly skeletal meats, such as pork shoulder, beef shoulder, beef flank and turkey thigh), but also that broader class of animal products recognized as “meat” by the food processing industry, such as meat by-products, chicken skin, pork heads, pork skirt, poultry meal, fish trimmings, fish meal, rendered meal, meat trimmings, animal liver, meat meal, meat and bone meal. It will, of course, be appreciated that the nature of those animals which are regarded as acceptable for human or even pet consumption may vary from time to time and will also, of course, vary with custom, culture and fashion. Typical meat sources which may be employed in the process of the invention are the flesh and by-products of chicken, pork, lamb, sheep, fish, octopus, squid, snake, dog, beef, turkey, horse, duck, venison, guinea fowl, birds other than those specifically mentioned above (including game birds), crabs and lobsters. Further, by “meat” it is meant high quality whole muscle or natural lean meat. The lean muscle meat for beef and pork has a high lean meat content of at least 70% with the remainder being the animal fat. Nomenclature for this lean muscle meat is 70/30. The beef and pork lean muscle meat has a high lean meat content of about 95% with the remainder being the animal fat. Nomenclature for this lean muscle meat is 95/5. Turkey and chicken lean muscle meats contain at least 78% lean meat content up to 96% lean meat content.

When a meat is employed in the soy protein containing food product, the meat is present at not more than 50% by weight on a moisture free basis, preferably not more than 25% by weight on a moisture free basis and most preferably at not more than 15% by weight on a moisture free basis.

The animal fat is a highly saturated triglyceride and as such, is a solid or waxy solid at room temperature. The animal fat is prepared from fat trimmings. It is a non-rendered fat, that is, not processed. The purpose of the animal fat is several fold. In one instance, the animal fat provides an additional meat like taste to the soy protein containing product. In another instance, the animal fat provides body to the soy protein containing product by virtue of being a solid at room temperature. In a further instance, a high fat content leads to a soft soy protein containing product. Animal fats having utility in the present invention comprise beef fat, pork fat or chicken fat. The animal fat is present in the soy protein containing food product at not more than 30% by weight on a moisture free basis.

When meat is employed in the process, prior to hydration of the soy protein material (A), the weight ratio of soy protein material (A) on a moisture free basis to the humectant (B) on a moisture free basis is generally from 10-50 to 1.

The invention having been generally described above, may be better understood by reference to the examples described below. The following examples represent specific but non-limiting embodiments of the present invention.

Examples 1 and 2 are directed to a meat free soy protein containing food product. Examples 3 and 4 are directed to a meat containing soy protein containing food product.

### EXAMPLE 1

Added to a vessel are 6 grams Colormaker Red No. 5417 colorant available from Colormaker Anaheim, Calif. and 300 grams of a first portion of hydration water. The colorant is permitted to hydrate for 0.3 hours while stirring. Then added are 150 grams of a dried low moisture (7% to 12%) soy protein material (A). The soy protein material (A) is permitted to hydrate for 0.3 hours while stirring. Stirring is continued and added are 50 grams beef bouillon, 13.5 grams egg albumin, 13.5 grams canola oil, 4.5 grams caramel color, 2.4 grams Natural Flavor Enhancer, 1.2 grams shitake extract and 100 grams of a second portion of hydration water. These ingredients are blended to obtain a thorough mixture. The mixture is then formed into slabs, strips, cutlets, patties or steaks as desired. This formation is carried out by hand or by machine. The formation is roasted at 300° C. to an internal temperature of 70° C. The roasted formation is permitted to cool to give to a meat free soy protein containing food product having the color appearance of a cooked medium rare steak.

### EXAMPLE 2

Added to a vessel are 300 grams of hydration water followed by 150 grams of a dried low moisture (7% to 12%) soy protein material (A). The soy protein material (A) is permitted to hydrate for 0.3 hours while stirring. Stirring is continued and added are 50 grams beef bouillon, 13.5 grams egg albumin, 13.5 grams canola oil, 4.5 grams caramel color, 2.4 grams Natural Flavor Enhancer, and 1.2 grams shitake extract. These ingredients are blended to obtain a thorough mixture. The mixture is then formed into slabs, strips, cutlets, patties or steaks as desired. This formation is carried out by hand or by machine. The formation is roasted at 300° C. to an internal temperature of 70° C. The roasted formation is permitted to cool to give to a meat free soy protein containing food product having the color appearance of a cooked medium rare steak.

### EXAMPLE 3

Added to a first vessel are 10 grams Colormaker Red No. 5417 colorant available from Colormaker Anaheim, Calif. and 450 grams of a first portion of hydration water. The colorant is permitted to hydrate for 0.3 hours while stirring. Then added are 225 grams of a dried low moisture (7% to 12%) soy protein material (A). The soy protein material (A) is permitted to hydrate for 0.3 hours while stirring. Added to a second vessel are 250 grains of a 3 mm grind of a beef 90, 10 grams of sodium chloride, 0.1 gram of sodium nitrite, 0.25 grams of sodium erythorbate, 3 grams of sodium tripolyphosphate and 50 grams of a second portion of hydration water. After the contents of both vessels are thoroughly combined, the contents of the first vessel are added to the second vessel. The contents are blended to obtain a thorough mixture. The mixture is then formed into slabs, strips, cutlets, patties or steaks as desired. This formation is carried out by hand or by machine. A beef fat of 50 grains of a 3 mm grind of a beef 20 is then sprinkled on the surface of the formation, along with 2 grams of black pepper and additional sodium chloride as desired. The formation is roasted at 300° C. to an internal temperature of 70° C. The roasted formation is permitted to cool to give to a meat containing soy protein containing food product having the appearance of a cooked medium well beef product.

### EXAMPLE 4

Added to a first vessel are 450 grams of a first portion of hydration water followed by 225 grams of a dried low moisture (7% to 12%) soy protein material (A). The soy protein material (A) is permitted to hydrate for 0.3 hours while stirring. Added to a second vessel are 250 grams of a 3 mm grind of a beef 90, 10 grams of sodium chloride, 3 grams of caramel color, 3 grams of sodium tripolyphosphate and 50 grams of a second portion of hydration water. After the contents of both vessels are thoroughly combined, the contents of the first vessel are added to the second vessel. The contents are blended to obtain a thorough mixture. The mixture is then formed into slabs, strips, cutlets, patties or steaks as desired. This formation is carried out by hand or by machine. A beef fat of 50 grams of a 3 mm grind of a beef 20 is then sprinkled on the surface of the formation, along with 2 grams of black pepper and additional sodium chloride as desired. The formation is roasted at 300° C. to an internal temperature of 70° C. The roasted formation is permitted to cool to give to a meat containing soy protein containing food product having the appearance of a cooked medium well beef product.

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A soy protein containing food product comprising;
(A) a soy protein material selected from the group consisting of a soy protein flour, a soy protein concentrate, a soy protein isolate and mixtures thereof;
(B) a humectant comprising
(i) a colorant and at least one selected from the group consisting of
(ii) a flavoring agent,
(iii) a triglyceride,
(iv) a food grade acid or acidic salt,
(v) a food grade base or basic salt, and
(vi) a food grade emulsion; and
(C) water.

2. The soy protein containing food product of claim 1 wherein (A) further comprises from about 1% up to about 20% by weight on a moisture free basis of a soy cotyledon fiber.

3. The soy protein containing food product of claim 2 wherein (A) further comprises from about 10% up to about 50% by weight on a moisture free basis of at least one selected from the group consisting of wheat flour and wheat gluten.

4. The soy protein containing food product of claim 3 wherein (A) further comprises from about 1% up to about 15% by weight on a moisture free basis of a starch.

5. The soy protein containing food product of claim 1 wherein (A) further comprises from about 2% up to about 20% by weight on a moisture free basis of at least one selected from the group consisting of a rice flour and a gluten free starch.

6. The soy protein containing food product of claim 1 wherein (A) further comprises from about 2% up to about 20% by weight on a moisture free basis of a starch and from about 2% up to about 20% by weight on a moisture free basis of at least one selected from the group consisting of a wheat flour and wheat gluten.

7. The soy protein containing food product of claim 4 wherein (A) contains from about 30% up to about 90% soy protein, by weight on a moisture free basis.

8. The soy protein containing food product of claim 1 wherein (A) is an extrudate having a moisture content of from about 4% up to about 80% by weight.

9. The soy protein containing food product of claim 1 further comprising up to about 50% by weight on a moisture free basis of a meat selected from the group consisting of beef, pork, turkey, and chicken.

10. A process for preparing a soy protein containing food product comprising the steps of: hydrating
(A) a soy protein material selected from the group consisting of at least one of a soy protein flour, a soy protein concentrate and a soy protein isolate, and; adding
(B) a humectant comprising
(i) a colorant and at least one of
(ii) a flavoring agent,
(iii) a triglyceride,
(iv) a food grade acid or acidic salt,
(v) a food grade base or basic salt, or
(vi) a food grade emulsion; and
mixing the hydrated soy protein containing material and the humectant to produce a soy protein containing food product having a moisture content of at least about 50% by weight.

11. The process of claim 10 wherein the soy protein material (A) is an extrudate having a moisture content of from about 4% up to about 80% by weight.

12. The process of claim 11 wherein the soy protein material (A) further comprises from about 1% up to about 20% soy cotyledon fiber, by weight on a moisture free basis.

13. The process of claim 12 wherein the soy protein material (A) further comprises from about 10% up to about 50% wheat gluten, by weight on a moisture free basis.

14. The process of claim 13 wherein the soy protein material (A) further comprises from about 1% up to about 15% starch, by weight on a moisture free basis.

15. The process of claim 14 wherein the soy protein material (A) further comprises from about 30% up to about 90% soy protein, by weight on a moisture free basis.

16. The process of claim 10 further comprising a meat selected from the group consisting of beef, pork, turkey, and chicken.

17. The process of claim 10 wherein the weight ratio of the soy protein material (A) on a moisture free basis to the humectant on a moisture free basis is from about 1-50 to 1.

18. The process of claim 10 wherein the weight ratio of the soy protein material (A) on a moisture free basis to the hydration water is from about 1 to 2-10.

19. The process of claim 10 wherein the soy protein containing food product is formed into strips, steaks, cutlets or patties; stuffed into casings; or shredded.
